(19) United States
(12) Patent Application Publication
(10) Pub. No.: US 2007/0017812 A1
(43) Pub. Date: Jan. 25, 2007

(54) Optimized Sample Injection Structures in Microfluidic Separations

(76) Inventor: Luc BOUSSE, Los Altos, CA (US)

Correspondence Address: WILSON SONSINI GOODRICH & ROSATI, 650 PAGE MILL ROAD, PALO ALTO, CA, 94304-1050, US

(21) Appl. No.: 11/278,132

(22) Filed: Mar. 30, 2006

Related U.S. Application Data
(60) Provisional application No. 60/666,968, filed on Mar. 30, 2005.

(51) Int. Cl. G01N 27/00

(52) U.S. Cl. 204/601

(57) ABSTRACT

Methods and apparatus for providing improved sample injection systems and microfluidic devices with structures such as microchambers that can provide relatively large sample volumes. The microchambers can be formed with a geometry to define sample plugs that can be symmetrical from the perspective of a sample load channel and a sample waste channel. Upon selective application of electrical fields, a defined amount of sample can be injected or loaded from a sample channel into the relatively larger interior volume of a sample chamber prior to ejection into a separation channel so that a sample volume can be separated electrophoretically.

This application claims the benefit of U.S. Provisional Application No. 60/666,968, filed Mar. 30, 2005, which is incorporated herein by reference in its entirety.

### FIELD OF INVENTION

The invention relates to sample introduction techniques and apparatus for microfluidic systems. More particularly, the invention relates to improved sample injection structures for defining accurate volumes of material for microfluidic separations.

### BACKGROUND OF THE INVENTION

Miniaturization is the recent trend in analytical chemistry and life sciences. In the past two decades, miniaturization of fluid handling and fluid analysis has been emerging in the interdisciplinary research field of microfluidics. Microfluidic applications cover microarrays, DNA sequencing, sample preparation and analysis, cell separation and detection, as well as environmental monitoring. The use of microfluidics in these applications attracts interest from both industry and academia, because of its potentials and advantages: small amounts of sample and reagent are required, less time consumption, lower cost and high throughput.

New microtechnologies and components have often been driven by the pharmaceutical industry's demand for high quality medicines produced at a rapid rate and a lower cost. In (bio)chemical and biological applications, miniaturization offers a solution to several challenges including increasing throughput, allowing automation, and decreasing costs by reducing the amount of expensive reagents used. In addition, miniaturization promises higher selectivity, higher yield, fewer byproducts, better reproducibility, efficient heat management, and increased process safety.

Numerous designs have been described in the literature for performing these operations in conjunction with particular protocols. In a microfluidic system where sample movement is controlled by electroosmotic and/or electrophoretic forces, by applying appropriate voltage gradients, the volume in which the molecules of interest reside can be relatively sharply delineated within a small volume, referred to as a plug. This operation is important in separations, when one wishes to have a high concentration of sample components to be detected in a sample plug, with little of the sample preceding or following the plug. There is interest in identifying different designs and protocols for carrying out plug formation followed by separation.

### INCORPORATION BY REFERENCE

All publications, patents and patent applications mentioned in this specification are herein incorporated by reference to the same extent as if each was specifically and individually indicated to be incorporated by reference.

### SUMMARY OF INVENTION

The invention herein provides improved sample injection systems and related methods to create and utilize microfluidic devices with structures that can produce relatively large sample volumes. The various designs and methodologies provided herein in accordance with the invention do not suffer from the same disadvantages associated with previous approaches relying on confined channel geometries such as the problem of time offset with a twin-T configuration. A preferable embodiment of the invention achieves this by providing microfluidic structures or regions with a geometry that is symmetrical from the perspective of both respective sides of a sample load channel and a sample waste channel, which essentially eliminates issues of time offset and its associated problems. More specifically, an embodiment of the invention provides microstructures that can sustain loading of sample volumes of relatively increased size. These may include a microfluidic sample chamber that is distinct from the adjoining microfluidic channels. The microfluidic chamber can be formed with variable dimensions that are modified laterally (two dimensions) in the plane of the device, and possibly also different in depth dimension (three dimensions) that can be relatively deeper or different from those of channels connected thereto. Several possible implementations of such sample chambers and their related methods of sample injection loading and formation are also provided in accordance with other aspects of the invention.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE FIGURES

FIG. 1 illustrates a top view of a chip with a substantially diamond shaped sample chamber for introducing a sample into a separation channel.

FIG. 2 illustrates an example of a microchip laboratory system including six reservoirs R₁, R₂, R₃, R₄, R₅, and R₆ connected to each other by a system of channels.

FIGS. 3a-b illustrate a plain cross design with a sample plug at an intersection with application of electrical fields.

FIG. 4a illustrates a pinched sample injection in a twin-T design.

FIG. 4b illustrates the initial phase of a separation where pull-back is applied from one side of a separation channel only.

FIGS. 5a-b illustrate sample chambers formed with a substantially diamond shape and a circular or curved shape, respectively.

FIG. 6 depicts microchambers formed with varying depths to provide increased sample volumes.

FIG. 7 depicts a portion of channels with reduced cross-sectional area.

FIG. 8a depicts a central support structure in the microchamber.

FIG. 8b depicts a central support structure which is relatively larger occupying a greater volume of the sample microchamber.

FIG. 8c depicts a multiplicity of smaller support structures in the microchamber.

The illustrations included within this specification describe many of the advantages and features of the invention. It shall be understood that similar reference numerals and characters noted within the illustrations herein may designate the same or like features of the invention. The illustrations and features depicted herein are not necessarily drawn to scale.

### DESCRIPTION OF THE INVENTION

The term “sample” used herein, means any molecule or mixture of molecules about which an assay endeavors to obtain more information. Typical examples include inorganic ions, organic or inorganic small molecules, biological molecules, and biological macromolecules such as peptides, proteins, and nucleic acids. More specifically, samples containing biomaterials that are macromolecules may comprise all or a portion of a nucleic acid or a protein. The protein or polypeptide may comprise an epitope, an antibody, an antibody fragment, an enzyme, or any other embodiment of a molecule containing peptide bonds. A biomaterial can be hormone, for example, the hormone may be a steroid for example, a sex steroid or a glucocorticoid, or a polypeptide hormone such as a cytokine. The sample may comprise all or a portion of an antibody or an antigenic material, or all or a portion of an enzyme. The sample may include blood, body fluids including amniotic fluid, cerebrospinal, pleural, pericardial, peritoneal, seminal and synovial fluid, in addition to blood, sweat, saliva, urine and tears, and tissue samples, and excreta, and environmental and industrial substances (including atmospheric gases, water and aqueous solutions, industrial chemicals, and soils). The sample may also include buffers, drugs and various other chemical compounds. The sample components may also include, but is not limited to, linkers, such as by way of example only, dithiobis(succinimidyl-undecanoate) (DSU), long chain succinimido-6[3-(2-pyridyldithio) propionamido]hexanoate (LCSPDP), which contains pyridyldithio and NHS ester reactive groups that react with sulflhydryl and amino groups, succinimidyl-6[3-(2-pyridyldithio)-propionamido]hexanoate (SPDP), which contains pyridyldithio and NHS ester reactive groups that react with sulflhydryl and amino groups, and m-maleimidobenzoyl-N-hydroxysuccinimide ester (MBS), which contains NHS ester and maleimide reactive groups that react with amino and sulfhydryl groups.

Microfluidic devices and structures have been used for electrokinetic sample movement, and electrokinetic separations (see U.S. Pat. No. 6,280,589 entitled Method for Controlling Sample Introduction in Microcolumn Separation Techniques and Sample Device, incorporated by reference herein it its entirety). Subsequent work demonstrated the ability of such microfluidic devices to perform separations much faster than conventional capillary electrophoresis using fused silica capillaries. This increase in speed is due to the ability of a microfluidic device to define the sample plug to be separated very accurately. A method was demonstrated to define a picoliter-sized sample plug by confining it at the intersection of two channels by electrical fields in all channel branches (see also U.S. Pat. No. 6,010,607 entitled Apparatus and Method for Performing Microfluidic Manipulations for Chemical Analysis And Synthesis, incorporated by reference herein it its entirety). Thus, a critical component of a microfluidic separation system is the intersection or intersections that define the sample plug that will be separated, together with the method of applying electrical fields as a function of time to create a sample plug.

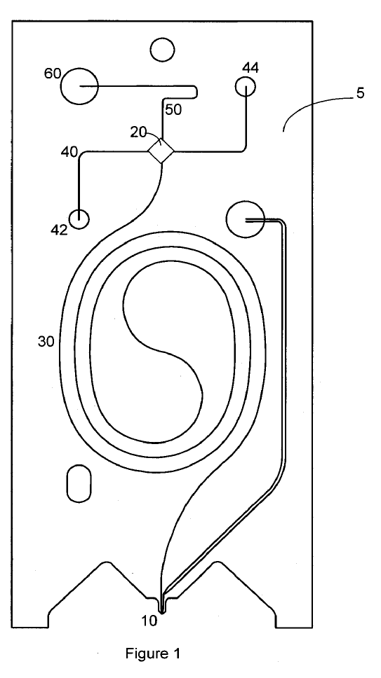

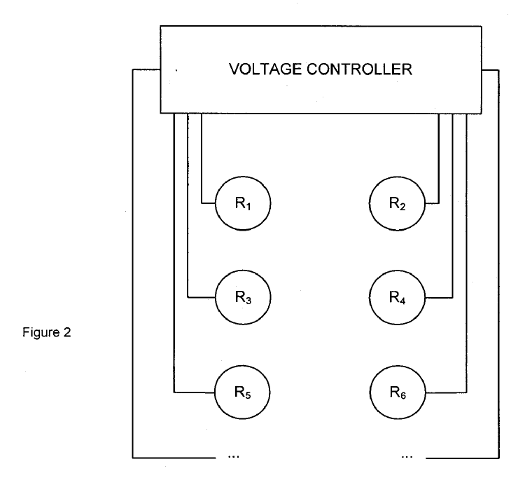

FIG. 1 illustrates a top view of a microfluidic chip 5 provided in accordance with an aspect of the invention that is formed with a recessed tip 10, a substantially diamond shape sample chamber positioned at a location where channels connecting to the chamber would otherwise intersect 20, and an “all curved” separation channel 30. Without limiting the scope of the present invention, the sample chamber depicted in FIG. 1 can also be substantially circular or curved shape. The all curved separation channel 30 is formed without or substantially without linear channel sections (straightaways) along a portion of the device 5. This exemplary embodiment of the invention provides a microfluidic chip that supports electrophoretic separation. A separation channel 30 may be included having a serpentine configuration leading to the recessed tip 10 portion at which sample and/or selected buffers or other solutions are sprayed off the chip 5. In addition, the chip 5 may include a sample channel 40 fluidly connected to a sample supply well 42 and a sample waste well 44. The sample chamber 20 may be formed at the intersection of the separation channel 30 with the sample channel 40 wherein the separation channel is perpendicular to sample channel. A buffer channel 50 may be formed substantially opposite to the separation channel 30. The buffer channel 50 may be formed of various lengths and may be in fluid communication with a buffer well 60. A preferable embodiment of the invention provides a substantially diamond shape sample chamber which is a cross sectional area measured by a distance between the boundaries of the sample channel 40, the boundaries of the buffer channel 50 and the separation channel 30 where the buffer channel and the separation channel intersect the sample channel. The sample chamber can geometrically define a sample volume. By applying an equal or balanced (electrokinetic) force, the buffer solution within buffer channel 50 may inject the sample volume or plug defined there between into the separation channel 30. The transport of an electrolyte buffer and sample is preferably accomplished by means of electric fields, which are created by switching electric potentials between electrodes of respective wells for the sample and between electrodes associated with buffer channels and separation channel for the buffer as is described in FIG. 2.

FIG. 2 is an example of a voltage control system for a microchip laboratory system. The laboratory system includes six wells or reservoirs R₁, R₂, R₃, R₄, R₅, and R₆ connected to a microchannel network formed upon the microchip (any number of reservoirs and corresponding channels can be selected optionally). Each well may be in fluid communication with a corresponding channel of the channel system. The materials stored in the wells preferably are transported electrokinetically through the channel system in order to implement the desired analysis or synthesis. To provide such electrokinetic transport, the laboratory system may include a voltage controller capable of applying selectable voltage levels, including ground, via electrodes positioned at each reservoir. Such a voltage controller can be implemented using multiple voltage dividers and multiple relays to obtain the selectable voltage levels. The voltage controller may be connected to an electrode positioned in each of the six wells by voltage lines in order to apply the desired voltages to the materials in the wells. The voltage controller may also preferably include sensor channels in order to sense the voltages present at those intersections. It shall be understood that electrokinetic movement can be directed on microfluidic devices herein in accordance with this aspect of the invention.

The base portion or substrate of the microfluidic chip as shown in FIG. 1 can be manufactured from glass, monocrystaline silicon or other materials known from semiconductor manufacture, or of a suitable polymer material such as poly or cyclo-olefins, polystyrene, glass, quartz, ceramic materials, silica based materials, polycarbonate or PMMA (polymethylmethacrylate). The chip may comprise a channel and reservoir or well system which is etched, micro-machined or otherwise established in its surface. Preferably techniques known from semiconductor manufacture can be applied for creating the channel system in the surface of the chip. The chip can be formed through holes which communicate with the channel system and are adapted to accommodate and hold the ends of capillary tubes. The chip may be also provided with various ports (not shown) for light waveguides that can be part of an optical detection system, such as a fluorescence detection system, or an absorption detection system, or a system for the detection of changes of the refractive index of a sample flowing through the channel system. The ports can be distributed anywhere along the illustrated channel systems herein thus allowing measurements at different locations along the channel system.

The invention provides microfluidic devices and methods for controlling sample introduction when employing microcolumn or microchannel separation techniques such as capillary electrophoresis (CE) as shown in FIG. 1. An electrolyte buffer and a concentrated sample are transported through a system of capillary channels of various designs and geometries. The sample is injected as a sample plug within a device which comprises channels for the electrolyte buffer and a sample loading channel and a waste channel, which can be viewed as two distinct channels in practice or different portions of a same sample channel. The channels for directing the electrolyte buffer, the sample loading channel and the waste channel for the sample may be formed to intersect each other. In some embodiments, the separation channel is positioned relatively opposite to the position of the buffer channel. A portion of a sample plug may be injected or discharged into the separation channel from a portion of the sample loading channel and waste channel, which may be substantially aligned relative another as shown in FIG. 1. The cross sectional area of the sample channel, measured by a distance between the boundaries of the sample loading channel and the sample waste channel and the boundaries of the buffer channel and the separation channel where the buffer channel and the separation channel intersect the sample channel, can be called a sample chamber. The sample chamber can geometrically define a sample volume. The buffer channels and the separation channel can be each inclined or perpendicular to the sample channel. The injection of the sample plug into the sample channel can be accomplished electrokinetically by applying an electric field across the sample well and the waste well for a time at least long enough that the sample component having the lowest electrophoretic mobility is contained within the geometrically defined volume. It shall be understood that the movement of the sample can also be accomplished by other driving forces such as pressure which are apparent to those of ordinary skill in the field.

In a further or subsequent step, following the introduction of sample into the defined portion of the sample channel, the electrolyte buffer may be (electrokinetically) advanced into the buffer channels symmetrically for a preselected period of time so that the well defined sample plug is injected into the separation channel. The amount of time selected may equal to at least the migration time of a slowest component within the sample plug from the intersection point between the buffer channel and the sample channel. In addition, a portion of the sample can be pushed back into the respective sample and waste channels and substantially prevented from uncontrollably diffusing into the electrolyte buffer which is transported in the sample channel. These methods provided in accordance with this aspect of the invention controls leakage of sample composition into the electrolyte buffer.

In order to ensure that the composition of the sample plug actually reflects the actual sample composition, the electric field across the sample and waste channels is preferably maintained for at least for a time period long enough that the geometrically defined sample volume is filled and contains the component of the sample which has the lowest electrophoretic mobility.

For example, by applying a positive electric potential to the buffer channel and a negative electric potential to the separation channel, the electrolyte buffer is electrokinetically transported through the capillary channel system to the separation channel. In order to introduce the sample into the channel, for example, the sample well for the sample is maintained at a positive potential and the waste well is kept on a negative potential. In the resulting electric field, the sample is transported electrokinetically from the sample well to the waste well. By this measure, a part of the sample channel is filled with sample. In other words, the volume of the sample plug is geometrically delimited by the spaced apart boundaries of the sample loading channel and the sample waste channel and the boundaries of the buffer channel and the separation channel where the buffer channel and the separation channel intersect the sample channel. In the aforementioned embodiment, the sample and waste wells were arranged opposite each other, such that the buffer channel and the separation channel form an ordinary crossing, the size and volume of the intersection determines the sample volume. By this measure the composition of the injected sample plug can reflect the actual sample composition.

When an electrophoretic analysis of a sample is to be carried out, an electric field can be first established between the buffer channel and the separation channel such that the electrolyte buffer is transported from the buffer channel to the separation channel. After the channel system of the chemical analysis system has been filled with the electrolyte buffer, the directing sample into the channel can be initiated (or alternatively, the buffer solution need not precede introduction of the sample). An electric field can be established between the sample well and the waste well such that sample is electrokinetically transported and drawn in from the sample well through the sample channel towards the waste channel and eventually into the waste well. It is understood that during the time period in which the sample is injected, the electric field between the buffer channel and the separation channel is switched off, or that the potentials are chosen such that the sample only is transported along the path described above. After the selected time period for applying the potential has elapsed to ensure that the sample volume between the sample well and the waste well is filled with the sample, the electric field between the sample well and the waste well is switched off. At the same time an electric field between the buffer channel and the separation channel can be activated again such that the sample contained within the sample channel is transported on into the direction of the separation channel. While the sample travels along the separation channel, the sample volume can be separated electrophoretically under the influence of the applied electric field.

The problem of leakage or diffusion of sample components into the electrolyte buffer while it is transported past the sample channel, even though no electric field is applied between the sample well and the waste well, is solved by allowing the electrolyte buffer to advance into the sample loading channel and into the waste channel for a time period, which amounts to at least the migration time tᵢ of the slowest component (i) within the sample plug from the sample chamber to the respective detector. Thus, the sample is pushed back into the sample loading and waste channels and substantially prevented from uncontrollably diffusing into the electrolyte buffer.

In order to allow the electrolyte buffer to advance into the sample and waste channels, the sample well and the waste well are switched on to create an electric potential which is different from the electric potential at the buffer channel, thus establishing a potential difference of suitable magnitude. In an embodiment of the invention where the electrolyte buffer is transported from a positive potential to a negative potential, the potentials at the sample well and the waste well are chosen negative with respect to the positive potential at the buffer channel. In case of a transport of the electrolyte buffer from a negative potential to a positive potential the potentials of the sample well and the waste well are chosen positive with respect to the buffer channel. In some embodiments of the invention, the potential difference between the buffer channel and the sample well and the waste well is chosen such that the resultant electric field has a field strength which amounts to at least about 0.1 V/cm.

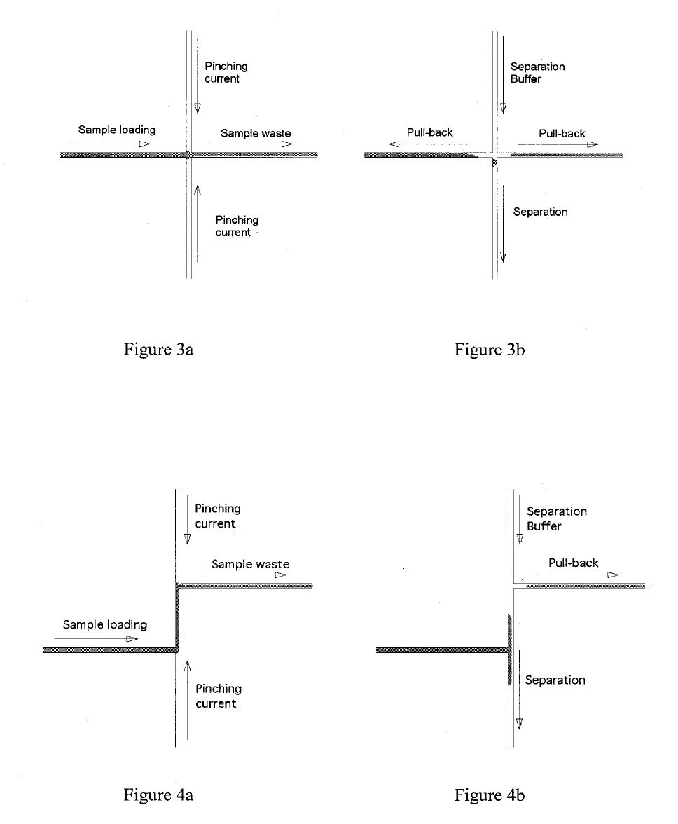

FIGS. 3a-b illustrate one of the most commonly applied procedures to define a sample plug at an intersection with application of appropriately oriented electrical fields using two phases (a)-(b), as follows. During phase (a), the sample is loaded in a relatively horizontal sample channel (as shown), from left to right, while an electrical field is applied in both segments of a relatively perpendicular separation channel from both directions towards the intersection as shown in FIG. 3a. This may be referred to as a pinched injection, and the operation of confining the sample at an intersection by applying such fields is commonly known as “pinching.” The loading step can continue as long as needed for all sample components of interest to reach the intersection. Then, in phase (b), the appropriate electrical fields can be switched on to begin moving the sample plug into the separation channel and to start the separation process. Meanwhile, at the same time, another set of electrical fields can be applied in the two branches of the sample channel to begin movement of the components present away from the intersection as shown in FIG. 3b. This application of fields in the sample channel branches is commonly known as “pull-back,” and it is often needed to separate the sample plug away from the rest of the excess sample being pulled back into branches of the sample channel. The absence of pull-back would likely lead to a continuous leakage of sample from the sample channels into the separation channel, which would in turn cause poor separations.

In order to elucidate the trade-offs involved in optimizing microfluidic separations, it is useful to analyze the separation performance in capillary electrophoresis. The separation quality can be determined by the magnitude of the dispersion present in a given component of a separation when it arrives at a detector. This can be expressed as:

$${σ}^{2} = \frac{{w}^{2}}{12} + 2 Dt$$

where σ is the spatial variance of the given component at the detector, w is the length of the injection plug, D is the diffusion coefficient of the molecules of the component, and t the separation time. Given that a separation time is provided by a separation length divided by relative velocity, this can also be written as:

$${σ}^{2} = \frac{{w}^{2}}{12} + \frac{2 DL}{μ E}$$
where L is the separation length, μ is the mobility, and E the electric field. This equation assumes that all other sources of dispersion, such as the size of the detector, thermal effects, wall adsorption, etc., are negligible. The quality of a separation is often characterized by N, the number of theoretical plates, which is given by:

$$N = \frac{{L}^{2}}{{σ}^{2}} = \frac{{L}^{2}}{( \frac{{w}^{2}}{12} + \frac{2 DL}{μ E} )}$$
More usefully, the resolution between two components in a separation is proportional to \sqrt{N}/4, which can be written as:

$$\frac{\sqrt{N}}{4} = \frac{L}{4 \sqrt{\frac{{w}^{2}}{12} + \frac{2 DL}{μ E}}}$$

This equation shows how resolution increases as the separation length increases. Initially, when the injection plug length term dominates, the separation resolution increases linearly with separation length. In this operating region, microfluidic devices are capable of producing very rapid and high-resolution separations by their ability to control w. However, as L increases, at some point the diffusion term will start to dominate, and the resolution will increase more slowly, namely as \sqrt{L}. In many cases, where high resolution is needed, L will need to be increased sufficiently to reach the point where the diffusion term dominates.

Another way to look at this last equation is to analyze how separation resolution is improved as the injection plug size is reduced. For relatively large plug sizes, the improvement will be linear, up to the point where the diffusion term takes over. At that point, there is no further improvement in resolution, but the signal amplitude continues to decrease in proportion to sample plug size. In most applications, sensitivity is as important a requirement as resolution, therefore it is important to ensure that the injection plug size is large enough to optimize both sensitivity and resolution. This can be done by ensuring that the dispersion coming from the injection plug size is similar in magnitude to the dispersion due to diffusion during the separation.

In most cases, this requirement may lead to a need for sample plugs larger than those obtained by a pinched injection at a simple intersection. Typically, such a pinched injection produces plug lengths of about 2 or 3 times the width of the channel. Researchers have described a method of increasing the sample plug size by using an offset channel intersection, as shown in FIGS. 4a-b, sometimes referred to as a “twin-T” intersection. This configuration allows the injection plug size to be adjusted to desired values by changing the offset distance between the two T intersections. This has proven to be a commonly used method, and the optimal sample plug size is usually considerably larger than the channel width.

However, there are some significant limitations and disadvantages associated with using the twin-T method of increasing a sample plug length. For example, when a twin-T design is used together with a pinched sample injection, as described above, the pinching field will cause some dilution of the material in the sample plug. As shown in FIG. 4a, the pinching current from a relatively bottom region of the separation channel will spill over into the twin-T area, where it will often dilute the sample. Thus, the twin-T structure often does not provide a completely geometric definition of the sample plug size.

Another disadvantage of the twin-T configuration is that each intersection is not symmetrical from the perspective of the side channels. To create a well-defined sample plug, during the separation phase, electrical fields in the side channel are preferably applied to remove the sample from the intersection, as described above. However, in a twin-T design, the pull-back for the two side sample channels are applied at a different time since the plug passes by these intersections at a different time. If a pull-back is applied too early, a portion of the sample plug will be unintentionally removed, and thus defeat a basic underlying purpose and function of the twin-T intersection. If pull-back is applied too late, the sample plug will have a tail portion which typically leads to poor separations. A relevant example shown in FIG. 4b depicts the initial phase of a separation during a selected time frame or window where pull-back is applied from one side of a separation channel only. The time needed for the sample plug to travel past the intersections in the twin-T depends on various factors such as the electric fields used, and also on the mobilities of all the components of the sample being separated. Accordingly, this means that for each assay being performed, the optimal time offset selected for the pull-back between the two channels will be likely different each time. Moreover, this optimization in each instance can be difficult to achieve, and would not be considered particularly robust since the optimal offset time can fluctuate as a function of many parameters, including the sample composition and its conductivity. It is also not possible or feasible to attempt optimization of the time offset simultaneously for multiple components with different mobilities. The lack of symmetry with respect to the twin-T design and its associated problems with timing offset during pull-back present severe drawbacks.

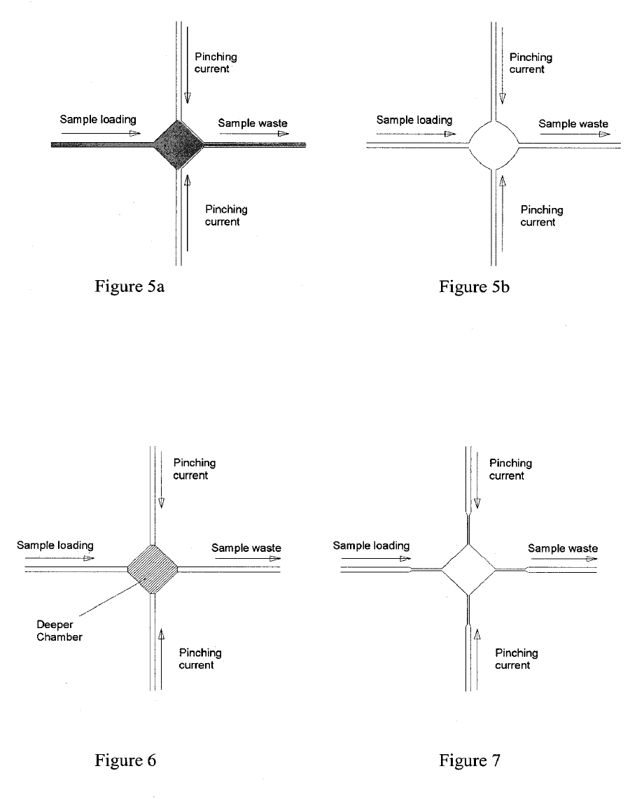

Various approaches to produce electrokinetic advancement of a buffer solution and a sample within a microfluidic device as described above are depicted in FIGS. 5-8. Methods and microfluidic devices provided herein include electrokinetic movement of the buffer and defined sample plug through the channels throughout herein. It should be noted however that the movement of sample and buffer can also be accomplished by other driving forces such as pressure driven alternatives. It should be further noted that the microfluidic devices illustrated herein may also include the apparatus formed with channels which are rotated by 90 degrees such that the buffer channel are shown relatively horizontal and the sample well relatively vertical.

An aspect of the invention provides methods to achieve sample volumes relatively larger than those formed by following conventional twin-T methods. FIGS. 5a-b illustrate sample chambers formed with a substantially diamond shape and a circular or curved shape, respectively, positioned at a location where channels connecting to the chamber would otherwise intersect. The channels for directing the electrolyte buffer, the sample loading channel and the waste channel for the sample may be formed to intersect each other and can be viewed as two distinct channels in practice or different portions of a same sample channel. The cross sectional area of the sample channel, measured by a distance between the boundaries of the sample loading channel and the sample waste channel and the boundaries of the buffer channel and the separation channel where the buffer channel and the separation channel intersect the sample channel, can be called a sample chamber. The sample chamber can geometrically define a sample volume. The injection of the sample into the sample channel can be accomplished electrokinetically by applying an electric field across the sample well and the waste channel for a time at least long enough that the sample component having the lowest electrophoretic mobility is contained within the sample chamber. It shall be understood that the movement of the sample can also be accomplished by other driving forces such as pressure which are apparent to those of ordinary skill in the field.

It should be observed that the size of the sample chamber structure does not have to be very large in order to provide the same comparable volume that is defined by a channel section between a twin-T intersection. The microstructures for defining samples provided herein are not restricted or confined by the limitations of a channel structure. For instance, a diamond shape chamber measuring 330 microns along each side will have the same area as a 2 mm long segment of a 50 micron wide channel. The precise shape of the chamber may not be relatively important; for instance the walls in some variations of the inventions may be curved as shown in FIG. 5b to increase the chamber volume. If pinching fields are used, as shown in FIG. 5a, there can be some dilution of the material in the chamber. However, compared to a twin-T configuration, the fraction of the chamber volume lost is relatively much smaller because the chamber dimensions are larger than a channel width. The amount of sample injected can be therefore expected to be more closely equal to the intended geometrically defined volume.

Another aspect of the invention provides microfluidic devices and related methods of operation using microchambers formed with varying depths to provide increased sample volumes. The selected volume of a sample chamber can be increased or otherwise modified by increasing or modifying the depth of the microstructure. The relative depth of the sample chamber may be greater or different relative to the depth selected in fabricating the channels. For example, as shown in FIG. 6, when the channels are 30 microns deep (cross-hatched section), it is quite feasible to also fabricate a chamber that is 100 to 200 microns deep. That would allow considerably greater sample volumes to be created yet occupy the same amount of space or footprint size along the lateral dimensions (two dimensions) of the microfluidic device. In a multi-layer microfluidic device, the sample chamber may be located on a separate layer from the channels. The multiple layers might be used, for example, to allow more convenient fabrication of different depths for various features on the device.

Another design feature that could be useful for microfluidic devices is to make the connections to the sample chamber narrower and/or shallower than the other channel portions leading up to the chamber as shown in FIG. 7. This may facilitate both the pinching process in the first step, and the pull-back in the second step of a separation, in the case that there are also pressure sources present. These pressure sources can be intentionally used (in the sample loading step, for instance), or may be unintended due to other considerations such as the surface tension forces at the wells at the end of the channels, or the negative pressure caused by an electrospray ionization device at the end of a channel. In microfluidic devices used under real or actual operating conditions, external pressure sources tend to be always present to some extent. A portion of channel with reduced cross-sectional area will both amplify the effect of the electrokinetic forces, since the electric field is higher, and reduce the effect of external pressures since the hydrodynamic resistance is usually higher. Accordingly, the result may create a zone where the pinching and the sample pull-back can occur with greater ease and precision. It shall be further understood that as with other designs and concepts presented herein, this aspect of the invention can be combined in many possible variations known to those of ordinary skill in the field such as creating an optimal design having curved sidewalls of a sample microchamber, a central support, and relatively shallow connections leading up to the sample chamber.

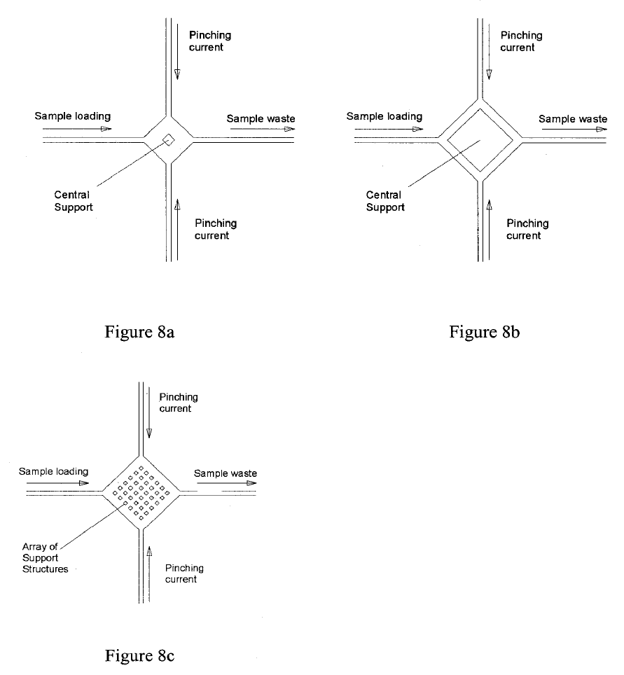

The use of a relatively large sample chambers in accordance with certain applications of the invention may present some incidental challenges. For example, in some fabrication processes, a covered large open area may tend to sag in a middle region if no support is present, particularly if the device is made of polymeric materials. The illustrations of the invention herein will include a covering or cover layer that encloses an underlying substrate layer wherein selected sample chambers can be formed. With certain microstructures provided herein, it has been observed that areas up to 100 or 200 microns wide typically present no apparent problems with sagging. But beyond that range of sizes, it may be preferable to construct and provide some mechanical support for the enclosed chamber to prevent sagging of the chamber covering as shown in the example depicted in FIG. 8a.

Another benefit conferred by a central support structure is to ensure a sample flow with less dispersion when moving from a sample microchamber into an adjacent separation channel. The material within the middle region of the sample flow would otherwise travel relatively faster than that at the edges without such as support structure. By limiting the width of an open area within the sample microchamber, such dispersion can be thereby reduced or minimized. As shown in FIG. 8b, another variation of the invention includes a design that carries this concept even further where both the diamond shaped chamber, and the central support structure are relatively larger occupying a greater volume of the sample microchamber which avoids creating an open area that is too large. Accordingly, a central support structure for the sample microstructures herein can serve alternate purposes and may provide what may be characterized as a spacer to control and vary the desired volume with a relatively larger sample microchamber.

Another type of structure that can provide a central support to avoid or reduce sagging utilizes a multiplicity of smaller support structures. FIG. 8c shows a structure with a regularly spaced array of smaller support pillars which can be otherwise positioned according to a desired pattern. Selected support structures formed in accordance with this embodiment of the invention have an advantage of being able to provide a maximal amount of support with a minimal impact on the sample volume in the chamber.

The overall symmetry and balance of the designs provided herein effectively enables pull-back to be performed with electrical fields applied from both sides of the microchamber at the same time. It shall be understood that these and other benefits provided by the invention are obtained by maintaining the relative left/right symmetry (as shown in the figures herein with relatively horizontal sample loading channel), but that it is possible to modify the relative up/down symmetry without losing these benefits.

Applications

The microfluidic structures disclosed herein have a wide variety of microsynthetic and microanalytic applications. Potential applications include pharmaceuticals, biotechnology, the life sciences, defense, public health, and agriculture, each of which has its own needs. Common fluids that can be used in microfluidic devices of the present invention include, but not limited to, whole blood samples, bacterial cell suspensions, nucleic acid mixtures, cell culture conditioned media, protein or antibody solutions, various buffers, and chemical processing streams. Microfluidic structures disclosed herein can be used to obtain a variety of interesting measurements including molecular diffusion coefficients, fluid viscosity, pH, electrophoretic mobility, electroosmotic mobility, chemical binding coefficients and enzyme reaction kinetics. Other applications for microfluidic devices include capillary electrophoresis, isoelectric focusing, immunoassays, flow cytometry, sample injection of proteins for analysis via mass spectrometry, PCR amplification, DNA analysis, cell manipulation, cell separation, cell patterning, flow-injection analysis, and chemical gradient formation. Many of these applications have utility for clinical diagnostics.

Ink-Jet Printing

A mature application of microfluidics technology is ink-jet printing, which uses orifices less than 100 μm in diameter to generate drops of ink. Inkjet printing now delivers reagents to microscopic reactors and deposit DNA into arrays on the surface of biochips. Biochips have been in the marketplace in various formats for several years. Biotechnology is increasingly about large numbers of experiments, such as analyses of DNA or drugs, screening of patients, and combinatorial synthesis, all of which are processes that require handling fluids. A single chip can serve many functions, including sample preparation, manipulation of live cells, perfusion of reagents, and analyte detection. Microfluidic devices provide a small analytical laboratory on a chip to identify, separate, and purify cells, biomolecules, toxins, and other materials.

Chromatography

The microfluidic structures disclosed herein could be used for performing numerous types of laboratory analysis or synthesis, such as by way of example only, DNA sequencing or analysis, capillary electrophoresis, electrochromatography, micellar electrokinetic capillary chromatography (MECC), inorganic ion analysis, and gradient elution liquid chromatography etc.

Capillary electrophoresis is widely used separation techniques in the biologically related sciences. It finds application in genetics, for DNA sequencing, single nucleotide polymorphism (“snp”) detection, identification of sequences, gene profiling, etc.; in drug screening, particularly high throughput drug screening, where the electrophoresis allows for the use of impure reagents, separation of entities that can interfere with detection of a signal, particularly an electromagnetic signal; for performing reactions by bringing together reactants and allowing for their automated separation, segregation, purification and analysis without manual intervention, and the like. Due to the highly efficient heat dissipation, capillary electrophoresis permits rapid and efficient separations of charged substances. Charged substances can be subjected to two electromigrating forces under the influence of the applied electrical potential at both ends of the capillary. One is electrophoresis, which is the force exercised by an electric field on charged molecules in solution, and which depends on the charge and size of the molecules and the electrical field strength. The electrophoretic velocity with which molecules move relative to the solution in which they are dissolved is equal to the product of the electrophoretic mobility and the local electric field. The other force is electroosmotic flow, or electroendosmotic flow (“EOF”) which consists of a bulk flow velocity of the solution relative to the walls, which is driven by the charge in the electrical double layer at the wall surface, and the electric field. The velocity of the electroosmotic flow is equal to the product of the electroosmotic mobility and the local electric field. Note that the EOF provides a fixed bulk velocity component, which tends to drive both neutral species and ionic species, regardless of their electrophoretic mobility, towards an electrode in relation to the charge on the wall of the capillary. The net velocity of an ionic species relative to the walls is therefore given by the sum of the electroosmotic mobility and the electrophoretic mobility, multiplied by the local electric field. Depending on the absolute value and sign of each mobility, a given ion can move towards the oppositely charged electrode (if the electrophoretic force is stronger), or toward the electrode with the same charge (if the electroosmotic force is stronger).

The structures described in this invention will function in the same way whether the sample movement is dominated by electrophoresis, electroosmosis, or both forces are of similar size. In the case of DNA separations, it is common to coat the wall surfaces such that charge is suppressed, and therefore no electroosomotic movement occurs. In that case only the charged molecules move. In the case that electroosmosis is present, there will be bulk movement of solution in the device. The mathematical description of both types of movement has been shown to be similar, however, since both are described by the product of a total mobility and the local electric field. Therefore, the structures described here will be effective at introducing controlled sample plugs in both cases.

Quantification

In applications envisaged for the microfluidic structures of the present invention, for chemical analysis or synthesis it may be necessary to quantify the material present in a channel at one or more positions similar to conventional laboratory measurement processes. Techniques typically utilized for quantification include, but are not limited to, optical absorbance, refractive index changes, fluorescence emission, chemiluminescence, various forms of Raman spectroscopy, mass spectrometry, electrical conductometric measurements, electrochemical amperiometric measurements, acoustic wave propagation measurements.

Optical absorbance measurements are commonly employed with conventional laboratory analysis systems because of the generality of the phenomenon in the UV portion of the electromagnetic spectrum. Optical absorbance is commonly determined by measuring the attenuation of impinging optical power as it passes through a known length of material to be quantified. Alternative approaches are possible with laser technology including photo acoustic and photo thermal techniques. Such measurements can be utilized with the microchip technology discussed here with the additional advantage of potentially integrating optical wave guides on microfabricated devices. The use of solid-state optical sources such as LEDs and diode lasers with and without frequency conversion elements would be attractive for reduction of system size.

Refractive index detectors have also been commonly used for quantification of flowing stream chemical analysis systems because of generality of the phenomenon but have typically been less sensitive than optical absorption. Laser based implementations of refractive index detection could provide adequate sensitivity in some situations and have advantages of simplicity. Fluorescence emission (or fluorescence detection) is a sensitive detection technique and is commonly employed for the analysis of biological materials. This approach to detection has much relevance to miniature chemical analysis and synthesis devices because of the sensitivity of the technique and the small volumes that can be manipulated and analyzed (volumes in the picoliter range are feasible). A laser source is often used as the excitation source for ultrasensitive measurements but conventional light sources such as rare gas discharge lamps and light emitting diodes (LEDs) are also used. The fluorescence emission can be detected by a photomultiplier tube, photodiode or other light sensor. An array detector such as a charge coupled device (CCD) detector can be used to image an analyte's spatial distribution.

Raman spectroscopy can be used as a detection method for microchip devices with the advantage of gaining molecular vibrational information. Sensitivity has been increased through surface enhanced Raman spectroscopy (SERS) effects. Electrical or electrochemical detection approaches are also of particular interest for implementation on microchip devices due to the ease of integration onto a microfabricated structure and the potentially high sensitivity that can be attained. The general approach to electrical quantification is a conductometric measurement, i.e., a measurement of the conductivity of an ionic sample. The presence of an ionized analyte can correspondingly increase the conductivity of a fluid and thus allow quantification. Amperometric measurements imply the measurement of the current through an electrode at a given electrical potential due to the reduction or oxidation of a molecule at the electrode. Some selectivity can be obtained by controlling the potential of the electrode but it is minimal. Amperometric detection is a less general technique than conductivity because not all molecules can be reduced or oxidized within the limited potentials that can be used with common solvents. The electrodes required for either of these detection methods can be included on a microfabricated device through a photolithographic patterning and metal deposition process. Electrodes could also be used to initiate a chemiluminescence detection process, i.e., an excited state molecule is generated via an oxidation-reduction process which then transfers its energy to an analyte molecule, subsequently emitting a photon that is detected.

Acoustic measurements can also be used for quantification of materials but have not been widely used to date. One method that has been used primarily for gas phase detection is the attenuation or phase shift of a surface acoustic wave (SAW). Adsorption of material to the surface of a substrate where a SAW is propagating affects the propagation characteristics and allows a concentration determination. Selective sorbents on the surface of the SAW device are often used. Similar techniques may be useful in the devices described herein.

Assays

Assays for detecting fluid samples, particularly complex fluids such as biological fluid samples, used for a variety of diagnostic, environmental, synthetic and analytical purposes in the medical, biological, chemical, biochemical and environmental arts are also with in the scope of the invention. A microfluidic diffusion immunoassay (DIA) may provide biochemical processes that are well suited to such miniaturized and simplified instrumentation. In this assay, the transport of molecules perpendicular to flow in a microchannel is affected by binding between antigens and antibodies. By imaging the steady-state position of labeled components in a flowing stream, the concentration of very dilute analytes can be measured in a few microliters of sample in seconds. This assay has been demonstrated in the format of a small molecule analyte competition immunoassay using fluorescence imaging detection. The DIA could, then, be used for monitoring drugs, hormones, and other small analytes.

Derivatization reactions are commonly used in biochemical assays. For example, amino acids, peptides and proteins are commonly labeled with dansylating reagents or o-phthaldialdehyde to produce fluorescent molecules that are easily detectable. Alternatively, an enzyme could by used as a labeling molecule and reagents, including substrate, could be added to provide an enzyme amplified detection scheme, i.e., the enzyme produces a detectable product. Such an approach has been used in conventional laboratory procedures to enhance detection, either by absorbance or fluorescence. A third example of a detection method that could benefit from integrated mixing methods is chemiluminescence detection. In these types of detection scenarios, a reagent and a catalyst are mixed with an appropriate target molecule to produce an excited state molecule that emits a detectable photon.

The invention can be advantageously used for microanalysis in research, especially biological research applications. This includes any application where it is advantageous to create an accurately defined volume of analyte. Such microanalyses include immunoassays, in vitro amplification routines, including polymerase chain reaction, ligase chain reaction and magnetic chain reaction. Molecular and microbiological assays, including restriction enzyme digestion of DNA and DNA fragment size separation/fractionation can also be accomplished using the microsystem of the invention. Microsynthetic manipulations, such as DNA fragment ligation, replacement synthesis, radiolabeling and fluorescent or antigenic labeling can also be performed using the microfluidic structures of the invention. Nucleic acid sequencing, using a variety of synthetic protocols using enzymatic replacement synthesis of DNA, can be performed, and resolution and analysis of the resulting nested set of single-stranded DNA fragments can be separated on the disk, identified and arranged into a sequence using resident software modified from such software currently available for macroscopic, automated DNA sequencing machines. Other applications include pH measurement, filtration and ultralfiltration, chromatography, including affinity chromatography and reverse-phase chromatography, electrophoresis, microbiological applications including microculture and identification of pathogens, flow cytometry, immunoassays and other heretofore conventional laboratory procedures performed at a macroscopic scale.

The microfluidic structures disclosed herein may be used for analytical instruments for environmental testing, industrial applications and regulation compliance. Portable, preferably hand-held embodiments, as well as more extensive embodiments, installed as part of an industrial quality control regime, may also be used. Applications for these embodiments of the invention include analyte testing, particularly testing for industrial effluents and waste material, to be used for regulatory compliance; and quality control of industrial processes, most advantageously of human consumable items, particularly pharmaceuticals and specifically endotoxin determinations. Application for testing, mixing and evaluating perfumes and other complex mixtures are also within the scope of the invention. In some applications, such as protein crystallization, microfluidic structures are used to mix reagents in precisely controlled ratios, without any detector being required. In these cases also, the present invention can advantageously be used to create a precisely defined reagent plug.

DNA Applications

The microfluidic structures disclosed herein can be used for a range of DNA-type analyses. The primary end use targeted by the DNA analysis chip can be in medical diagnostics, to detect genetically related disease directly at the point of care without the delays of laboratory testing. Other applications of the DNA analysis chip include drug discovery—the search for more effective new drugs, the testing of livestock for genetic disease, forensic science, and the monitoring of water supplies for biological contamination.

The microfluidic structures disclosed herein can be used for PCR analysis. DNA typing is achieved from whole blood samples using capillary microfluidics and capillary array electrophoresis whereby blood is used directly as the sample template for a PCR amplification analysis.

The microfluidic structures disclosed herein can also be used for the detection of very low numbers of DNA molecules, i.e. potentially individual molecules. Electrophoretic mobility shift assays for the detection of DNA-protein interactions can also be carried out in a microfluidic chip environment. Some of the benefits achieved are reduced sample volumes, an avoidance of labeling procedures and decreased analysis times.

The hybridisation time for DNA arrays can be accelerated using plastic microfluidic chips, comprising networks of microfluidics channels plus an integrated pump.

Protein Applications

Microfluidic structures disclosed herein may also be used in the analysis of proteins/peptides and biomarker discovery. In particular, microfluidics can be linked with a mass spectrometric analysis of proteins or peptides. Thus, peptides can be adsorbed onto hydrophobic membranes, desalted, and through the use of microfluidics eluted in a controlled manner to allow the direct mass spectrometric analysis of picomole amounts of peptides by electrospray ionisation mass spectrometry procedures. Combinatorial peptidomics approaches can be used with microfluidic structures disclosed herein and allow identification of tryptic peptides directly from the crude proteolytic digest. Combinatorial peptidomics initially utilises peptidomics where a protein sample is proteolytically digested prior to assaying, and combines it with a combinatorial depletion of the digest (peptide pool) by chemical cross-linking via amino acid side chains to allow a subsequent profiling of the resulting sample. The invention herein may be further applied to apparatus and methods set forth in U.S. patent application Ser. No. 10/871,498 (US2005-0047969), incorporated by reference herein in its entirety.

Other protein analysis methods can be used with microfluidic structures disclosed herein linked to membranes imprinted with trypsin. This allows the amount of protein delivered to the membrane, the reaction temperature within the device and the reaction time to be directly controlled for optimal digestion. Thus, using microfluidics the sample can be supplied directly from upstream processing procedures, e.g. purification products from cell lysates. The peptide mixture can subsequently be analyzed by electrospray ionisation mass spectrometry.

Other protein analysis methods can be used with the microfluidic structures disclosed herein for protein size determination and/or quantitation by electrophoresis, with detection by optical methods such as absorption or fluorescence. Precise volumes of the injected material, provided by the optimized injection structures are necessary for adequate separation resolution and reproducible quantitation.

The development of protein microarray methods analogous to DNA microarray technologies, for protein/peptide is of pharmacological value. As is the case with DNA microarrays, sample volumes required for analysis are low, the sensitivity of the assay is high (particularly for low-abundance proteins), and binding times are kept to a minimum in order to produce an efficient assay. A system incorporating protein microarrays, fluorescent detection and integrated microfluidics in combination may enable quantitative measurements for protein profiling to be carried out with high sensitivity and also require shorter analysis times than static binding experiments.

While the invention has been described with reference to the aforementioned specification, the descriptions and illustrations of the preferable embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art upon reference to the present disclosure. It is therefore contemplated that the appended claims shall also cover any such modifications, variations and equivalents.

1. A microfluidic device comprising:
a sample chamber having an interior region configured with a predetermined shape for geometrically defining a sample volume containing components of interest;
a sample loading channel and a sample waste channel each in fluid communication with the sample chamber which are configured in a symmetrically opposite orientation relative to each other; and
a separation channel having an incoming channel portion and an outgoing channel portion relative to and in fluid communication with the sample chamber for transporting the sample volume for separation of its components of interest.

2. The microfluidic device of claim 1 wherein the sample volume is comparatively larger than a reference volume defined by the width of the separation channel multiplied by its cross-section.

3. The microfluidic device of claim 2 wherein the sample volume is at least three times larger than the reference volume defined by the width of the separation channel multiplied by its cross-section.

4. The microfluidic device of claim 2 wherein the sample volume can be further defined by a variable depth of the sample chamber.

5. The microfluidic device of claim 1 wherein a dimension of the sample chamber is relatively greater than the width of the sample loading channel or separation channel multiplied by its cross-section.

6. The microfluidic device of claim 1 wherein the sample chamber is selected from one of the following: a diamond shape, a circular shape or a curve shape.

7. The microfluidic device of claim 1 wherein a portion of the channels is defined with a reduced cross-sectional area relative to the width of the sample loading channel or separation channel.

8. A microfluidic device comprising:
a sample chamber having an interior region configured with a predetermined shape for geometrically defining a sample volume containing components of interest;
a sample loading channel and a sample waste channel each in fluid communication with the sample chamber which are configured in a symmetrically opposite orientation relative to each other; and
a separation channel having an incoming channel portion and an outgoing channel portion relative to and in fluid communication with the sample chamber for transporting the sample volume for separation of its components of interest;
wherein the interior region of the sample chamber contains a support structure around which the sample volume can be formed and substantially enclosed with an enclosure layer.

9. The microfluidic device of claim 8 wherein the support structure supports the enclosure layer and is designed to reduce sagging of the enclosure layer.

10. The microfluidic device of claim 8 wherein the support structure is configured to provide a sample flow with reduced dispersion.

11. The microfluidic device of claim 8 wherein the support structure comprises a plurality of smaller support structures.

12. The microfluidic device of claim 8 wherein the sample chamber is formed with a geometric shape from one of the following: a diamond shape, a circular shape or a curve shape.

13. The microfluidic device of claim 8 wherein a portion of the channels have reduced cross-sectional area in proximity to the sample chamber.

14. An apparatus for manipulating a sample volume within a microfluidic device, which microfluidic device comprises:
a sample chamber having an interior region configured with a predetermined shape for geometrically defining a sample volume containing components of interest;
a sample loading channel and a sample waste channel each in fluid communication with the sample chamber which are configured in a symmetrically opposite orientation relative to each other;
a buffer channel and a separation channel configured in a symmetrically opposite orientation relative to each other, and each in fluid communication with the sample chamber for transporting the sample volume for separation of its components of interest, and
means for electrokinetically manipulating a sample into the sample loading channel towards the sample chamber, and away from the sample chamber in the sample waste channel, by selectively applying an electrical field across the sample channel and the waste channel.

15. The apparatus of claim 14 wherein the sample substantially occupies the sample chamber to provide the sample volume containing components of interest.

16. The apparatus of claim 15 wherein an electric field is applied across the buffer channel and the separation channel to manipulate to direct the sample volume into at least a portion of the separation channel.
